(19) United States
(12) Patent Application Publication
(10) Pub. No.: US 2021/0374099 A1
(43) Pub. Date: Dec. 2, 2021

(54) Method, Device and System for Asychronous Directory Replication

(71) Applicant: HUAWEI TECHNOLOGIES CO., LTD., SHENZHEN (CN)

(72) Inventors: Naveen Raju, Bangalore (IN); James Namboorikandathil Joseph, Bangalore (IN)

(21) Appl. No.: 17/358,720

(22) Filed: Jun. 25, 2021

Related U.S. Application Data
(63) Continuation of application No. PCT/CN2019/127242, filed on Dec. 21, 2019.

(30) Foreign Application Priority Data
Dec. 28, 2018 (IN) 201831049644

(51) Int. Cl. G06F 16/16; G06F 16/14; G06F 16/11; G06F 16/182

(52) U.S. Cl. CPC G06F 16/164; G06F 16/152; G06F 16/1734; G06F 16/1827; G06F 16/128

(57) ABSTRACT

A method, a device and a system for asynchronous directory replication is disclosed. The method comprises: configuring an inode identifier of an object stored in a source NAS, the inode identifier of the object having a first inode space identifier and a first local inode identifier, wherein the first inode space identifier indicates that the object is created by the source NAS; copying the object to a target NAS to be stored as a target object, wherein an inode identifier of the target object having a second inode space identifier and a second local inode identifier, wherein the second inode space identifier indicates that the target object is received from the source NAS, and wherein the second local inode identifier is identical to the first local inode identifier, and creating a mapping between the first inode space identifier and the second inode space identifier.

### CROSS-REFERENCE TO RELATED APPLICATIONS

This application is a continuation of International Application No. PCT/CN2019/127242, filed on Dec. 21, 2019, which claims priority to India Patent Application No. 201831049644, filed on Dec. 28, 2018. The disclosures of the aforementioned applications are hereby incorporated by reference in their entireties.

### TECHNICAL FIELD

The present subject matter described herein, in general, relates asynchronous directory replication in arrays, and more particularly, to a method, a device and a system for asynchronous directory replication by creating unique inode space identifiers and maintaining inode space tables for mapping.

### BACKGROUND

Network-attached storage (NAS) is a file-level computer data storage server connected to a computer network providing data access to a heterogeneous group of clients. NAS is specialized for serving files either by its hardware, software, or configuration.

Most NAS arrays support asynchronous replication as a disaster recovery solution. Asynchronous replication is commonly implemented using Snapshot technology, where periodic snapshots of the source filesystem are taken and differences between these snapshots are replicated to the destination filesystem. Snapshots are point in time copies of the filesystem. It is also known that a ‘pair’ is a relationship established between a primary and a secondary filesystem for replication purposes, and once a pair is created, one can synchronize the pair, which creates a snapshot at a source and copies the data from source to destination. Later pairs can be periodically synchronized using a schedule, for example in every 5 minutes, every day, etc. For efficiency of transfer, this type of synchronization only copies the changes between snapshots.

In large filesystems, such as the Scale-out filesystems, a filesystem to filesystem asynchronous replication may not be practical because of some of the reasons indicated herein below, such as:

a) Large amount of data to be replicated

b) Not every piece of data needs to be protected at same Recovery Point Objective (RPO)

c) Temporary data does not need to be protected.

In view of these limitations, asynchronous directory replication is one of the preferred capabilities supported by Scale-out filesystems such as Isilon's syncIQ directory replication solution.

Pair in directory replication is established between a directory in a primary filesystem and another directory in a secondary filesystem as shown in FIG. 1. Typically for efficient replication, a changed block of a file in an increment, has to be replicated to the same file in the destination. In the case of a directory, this file may have a different path and may have a different identifier, like inode number. Therefore, a mapping from source inode number to target inode number is required to allow this scenario to optimally replicate the changes to the destination object. This is because the identifiers like inode numbers are unique in the filesystem. These identifiers need not be inode numbers, but something which the filesystem uses to identify an object in the filesystem.

Further considering a scenario as represented in FIG. 2 wherein a directory FS1/D3 from source filesystem is replicated to FS2/D3. Inode numbers are unique in the filesystem, so FS1 and FS2 will have their own independent inode numbers. When directory replication is performed, for each source object, a corresponding destination object is created but that object will have a different inode number. For example, file D3/D5/f3 in FS1 has inode number 104. But the same file in FS2 has inode number 258. The typical solution for such problems is to maintain a table that has mapping of source inode number to target inode number. The mapping table can be maintained either in source or in target, or in both places, with varying degrees of capabilities as indicated in the mapping table from source to destination and also illustrated in FIG. 3.

TABLE 1
The mapping table from source to destination.

| Source | Target |
|---|---|
| Node | Node |
| 102 | 251 |
| 103 | 252 |
| 106 | 257 |
| 107 | 254 |

Additionally, in case of a Scale-out filesystem, the directory could span across different nodes which requires mapping table to be distributed across multiple nodes. The distribution of this table can be done by sharding, but updates and lookups for this table need communication across multiple nodes which could increase the latency of update/lookup, thus reducing overall replication performance. Moreover, the mapping table can grow very large, and consume large amount of space.

Therefore, it can be inferred from the problems discussed hereinabove that there is a need to reduce the overhead of a lookup, update operations on the distributed mapping table and to reduce space requirement for maintaining the mapping table. Thus, the present disclosure provides a solution that addresses latency and space requirements of the existing solution.

The above-described need for addressing latency and space requirements is merely intended to provide an overview of some of the shortcomings of conventional systems/mechanism/techniques, and is not intended to be exhaustive. Other problems/shortcomings with conventional systems/mechanism/techniques and corresponding benefits of the various non-limiting embodiments described herein may become further apparent upon review of the following description.

### SUMMARY

This summary is provided to introduce concepts related to, a method, a device and a system for asynchronous directory replication, and the same are further described below in the detailed description. This summary is not intended to identify essential features of the claimed subject matter nor is it intended for use in determining or limiting the scope of the claimed subject matter.

An objective of the present disclosure is to provide asynchronous directory replication by creating unique inode space identifiers and maintaining inode space tables for mapping.

Another objective of the present disclosure is to reduce the overhead of a lookup, update operations on the distributed mapping table and to reduce space requirement for maintaining the mapping table.

Yet another objective of the present disclosure is to provide a method for asynchronous directory replication.

Yet another objective of the present disclosure is to provide a device for asynchronous directory replication.

Yet another objective of the present disclosure is to provide a system for asynchronous directory replication.

In particular, the present disclosure involves InodeSpaceID remapping during replication to reduce the overhead of a lookup, update operations on the distributed mapping table and to reduce space requirement for maintaining the mapping table.

According to a first aspect of the disclosure, there is provided a method for asynchronous replication between network-attached storage (NAS) arrays. The method comprises the steps of: configuring, by a source NAS, an inode identifier of an object stored in the source NAS, the inode identifier of the object having a first inode space identifier and a first local inode identifier, wherein the first inode space identifier indicates that the object is created by the source NAS; copying, by the source NAS, the object to a target NAS to be stored as a target object, wherein an inode identifier of the target object having a second inode space identifier and a second local inode identifier, wherein the second inode space identifier indicates that the target object is received from the source NAS, and wherein the second local inode identifier is identical to the first local inode identifier; and creating, by the source NAS, a mapping between the first inode space identifier and the second inode space identifier.

In a first possible implementation of the method according to the first aspect, the object includes a file or a directory.

In a second possible implementation of the method according to the first aspect, all of objects created by the source NAS shares the first inode space identifier.

In a third possible implementation of the method according to the first aspect, the first inode space identifier is zero, and the second inode space identifier is a non-zero value.

In a fourth possible implementation of the method according to the first aspect, the source NAS and the target NAS each comprises at least one file system.

In a fifth possible implementation of the method according to the first aspect, creating the mapping between the first inode space identifier and the second inode space identifier comprises: mapping the first inode space identifier to a file system; and mapping the file system to the second inode space identifier.

According to a second aspect of the disclosure, there is provided a system for asynchronous replication between network-attached storage (NAS) arrays. The system comprises at least one target NAS; and at least one source NAS. The source NAS is adapted to: configure an inode identifier of an object stored in the source NAS, the inode identifier of the object having a first inode space identifier and a first local inode identifier, wherein the first inode space identifier indicates that the object is created by the source NAS. It is also adapted to copy the object to the target NAS to be stored as a target object, wherein an inode identifier of the target object having a second inode space identifier and a second local inode identifier, wherein the second inode space identifier indicates that the target object is received from the source NAS, and wherein the second local inode identifier is identical to the first local inode identifier. It is further adapted to create a mapping between the first inode space identifier and the second inode space identifier.

In a first possible implementation of the system according to the second aspect, the object includes a file or a directory.

In a second possible implementation of the system according to the second aspect, all of objects created by the source NAS shares the first inode space identifier.

In a third possible implementation of the system according to the second aspect, the first inode space identifier is zero, and the second inode space identifier is a non-zero value.

In a fourth possible implementation of the system according to the second aspect, the source NAS and the target NAS each comprises at least one file system.

In a fifth possible implementation of the system according to the second aspect, creating the mapping between the first inode space identifier and the second inode space identifier comprises: mapping the first inode space identifier to a file system; and mapping the file system to the second inode space identifier.

According to third aspect of the disclosure, there is provided a device for asynchronous replication between network-attached storage (NAS) arrays. The device comprises an identifier module, a storage module and a mapping module. The identifier module is adapted to configure an inode identifier of an object stored in a source NAS, the inode identifier of the object having a first inode space identifier and a first local inode identifier, wherein the first inode space identifier indicates that the object is created by the source NAS. The storage module is adapted to copy the object to a target NAS to be stored as a target object, wherein an inode identifier of the target object having a second inode space identifier and a second local inode identifier, wherein the second inode space identifier indicates that the target object is received from the source NAS, and wherein the second local inode identifier is identical to the first local inode identifier. The mapping module is adapted to create a mapping between the first inode space identifier and the second inode space identifier.

In a first possible implementation of the device according to the third aspect, creating the mapping between the first inode space identifier and the second inode space identifier comprises: mapping the first inode space identifier to a file system; and mapping the file system to the second inode space identifier.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The detailed description is described with reference to the accompanying figures. In the figures, the digit(s) of a reference number identifies the figure in which the reference number first appears. The same numbers are used throughout the drawings to refer like features and components.

FIG. 1 illustrates creation of replication pairs, as prior art of the present disclosure.

FIG. 2 illustrates an exemplary directory replication, as prior art of the present disclosure.

FIG. 3 illustrates creating mapping table from source to destination, as prior art of the present disclosure.

FIG. 4(a), FIG. 4(b), FIG. 4(c), FIG. 4(d), and FIG. 4(e), illustrate the replication operations, in accordance with an example of the present disclosure.

FIG. 5(a), FIG. 5(b), FIG. 5(c), FIG. 5(d), and FIG. 5(e), illustrate the replication operations, in accordance with another example of the present disclosure.

FIG. 6 illustrates flow-chart of the method for asynchronous directory replication, in accordance with an embodiment of the present disclosure.

FIG. 7 illustrates a block diagram of the system for asynchronous directory replication, in accordance with another embodiment of the present disclosure.

FIG. 8 illustrates a block diagram of the device for asynchronous directory replication, in accordance with another embodiment of the present disclosure.

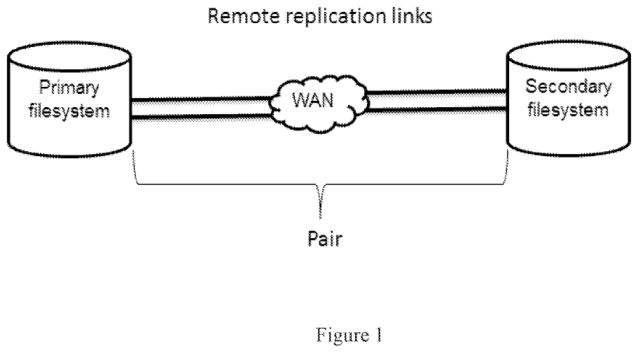

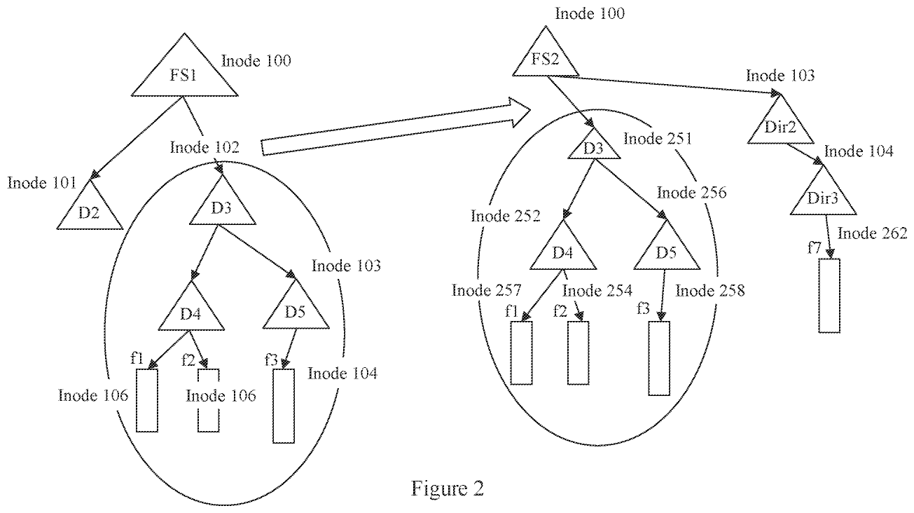

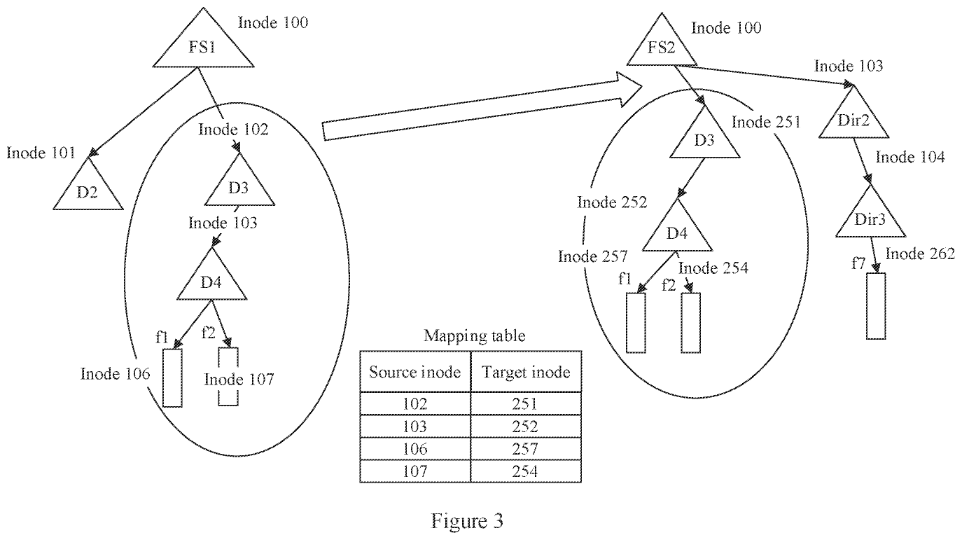

It is to be understood that the attached drawings are for purposes of illustrating the concepts of the disclosure and may not be to scale.

### DETAILED DESCRIPTION OF ILLUSTRATIVE EMBODIMENTS

The following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure can be implemented in numerous ways, as a process, an apparatus, a system, a composition of matter, a computer readable medium such as a computer readable storage medium or a computer network wherein program instructions are sent over optical or electronic communication links. In this specification, these implementations, or any other form that the disclosure may take, may be referred to as techniques. In general, the order of the steps of disclosed processes may be altered within the scope of the disclosure.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

In the following detailed description, numerous specific details are set forth in order to provide a thorough understanding of the disclosure. However, it will be understood by those skilled in the art that the present disclosure may be practiced without these specific details. In other instances, well-known methods, procedures, and components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

In the present disclosure, “asynchronous directory replication” refers to a data protection feature in which source directory of a filesystem is replicated to destination directory of a different filesystem asynchronously on regular intervals. The source and destination filesystems are typically located in two different geographical sites.

In the present disclosure, “inode” refers to a data structure on a filesystem that stores all the information about a file except its name and its actual data. An inode is identified using an inode number in the filesystem.

In the present disclosure an “inode space” is a partitioning in the set of all inode numbers in the filesystem. An inode space refers to a sub-range of inode numbers in the whole range of inode numbers in the filesystem.

In the present disclosure, “inode space identifier” aka InodeSpaceID identify a single inode space.

In the present disclosure, “distributed mapping table” refers to a table whose contents are distributed across multiple nodes of a cluster.

In the present disclosure, “LocalInodeID” refers to identifier of the inode with in an inode space.

In the present disclosure, “InodeSpaceTable” is a distributed mapping table containing the mapping between GUID of the filesystems and corresponding inode space identifiers.

In the present disclosure, “forward replication” refers to replication of data from source directory of a filesystem to destination directory of a filesystem

In the present disclosure, “reverse replication” refers to replication of data from destination directory of a filesystem to source directory of a filesystem. Typically used during failback usecases.

GUID of a filesystem is a globally unique identifier assigned to a filesystem when it is created. GUID assigned to a filesytem will not conflict with another filesystem created in any storage system.

A method, a device and a system for asynchronous directory replication are disclosed. While aspects are described for asynchronous directory replication in NAS arrays to addresses latency and space requirements of the existing solutions, the present disclosure may be implemented in any number of different computing systems, environments, and/or configurations, the embodiments are described in the context of the following exemplary systems, devices/nodes/apparatus, and methods.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

The present disclosure provides a method, a device and a system for asynchronous directory replication by creating unique inode space identifiers and maintaining inode space tables for mapping, in order to reduce the overhead of lookup and update operations on the distributed mapping table and to reduce space requirement for maintaining the mapping table.

Contrary to the existing asynchronous replication techniques, in the present disclosure, all inodes in a filesystem are separated into different inode spaces by splitting the inode identifier into two parts i.e. “InodeSpaceID” and “LocalInodeID”. For example, a 64-bit inode number could be split into 10-bit InodeSpaceID and 54-bit LocalInodeID (inode number). But the externally visible inode number will still be 64-bit. Moreover, all inodes created in the local filesystem will have InodeSpaceID as 0. All inodes replicated from other filesystems to the current filesystem through replication will have a non-zero InodeSpaceID, which is an index into an InodeSpaceTable.

Significantly, every filesystem maintains an InodeSpaceTable which contains InodeSpaceIDs of all the remote filesystems with which it has a replication relationship. When a replication pair is created, InodeSpaceTable table is updated with a new InodeSpaceID for the remote filesystem. Every inode transferred from this remote filesystem contains this new InodeSpaceID. This makes sure that the inodes from source filesystem does not conflict with the destination filesystem. There are special cases like a Fan-out scenario, which results in generation of a new InodeSpaceID for a filesystem-directory pair. InodeSpaceTable is persistent permanently till the existence of the filesystem.

When new replication is configured with a new filesystem, filesystems exchange the InodeSpaceTable information and store it locally. This exchange is used by filesystems to assign new InodeSpaceIDs to any previously unknown filesystem. GUID (Globally Unique Identifier) of filesystems is used to represent a filesystem in the InodeSpaceTable eliminating the possibility of collision. Each filesystem's InodeSpaceTable is unique i.e., filesystem X assigns its own unique InodeSpaceID to a filesystem Y, but it need not be the same InodeSpaceID which filesystem Z assigns to filesystem Y.

The mapping problem associated with the prior art is solved by performing InodeSpaceID remapping during replication. Firstly, when an inode is replicated from source to destination, destination filesystem lookup InodeSpaceTable of the source filesystem to find out where this inode was created i.e. get GUID of the filesystem where this inode was created. Subsequently, looking up the destination filesystem InodeSpaceTable with this GUID to get mapped with InodeSpaceID. Thereafter, this mapped InodeSpaceID is used to create the inode in the destination filesystem.

In special scenarios, new InodeSpaceID is assigned in case of fan-out/fan-in replication.

Significantly, file and directory moves between replicated directories is not allowed which is a common restriction in most directory based replication solutions.

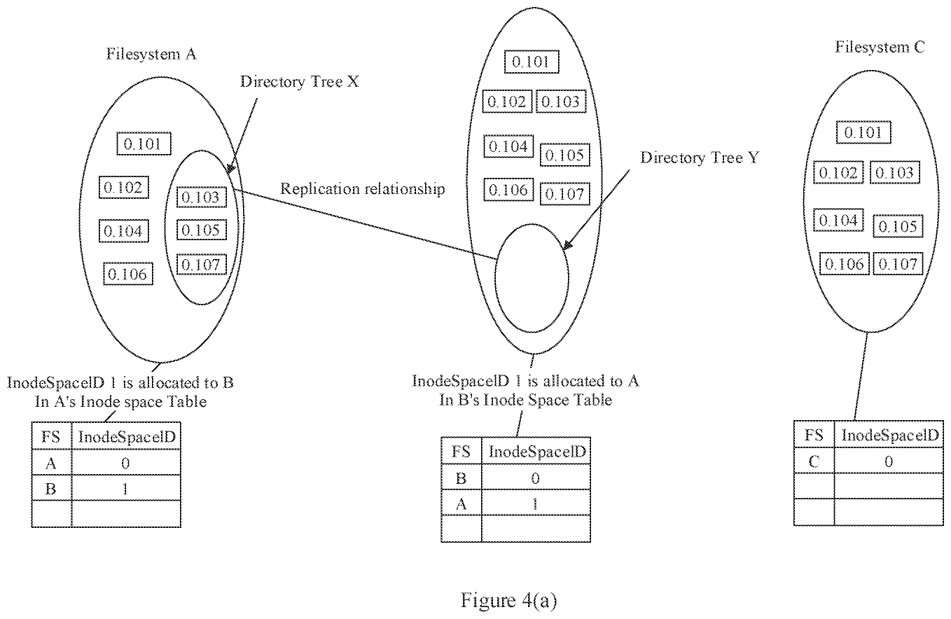

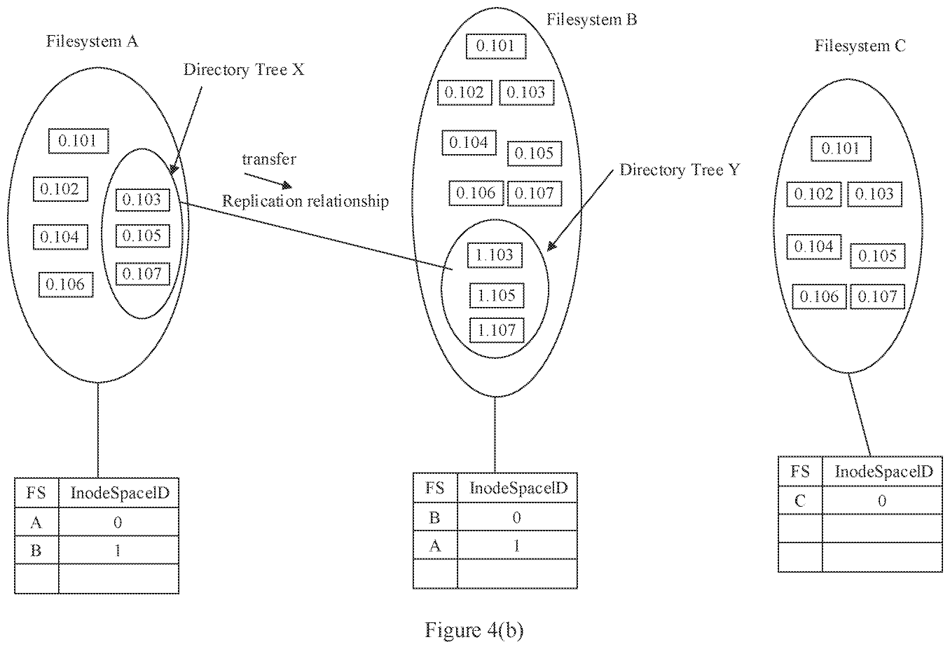

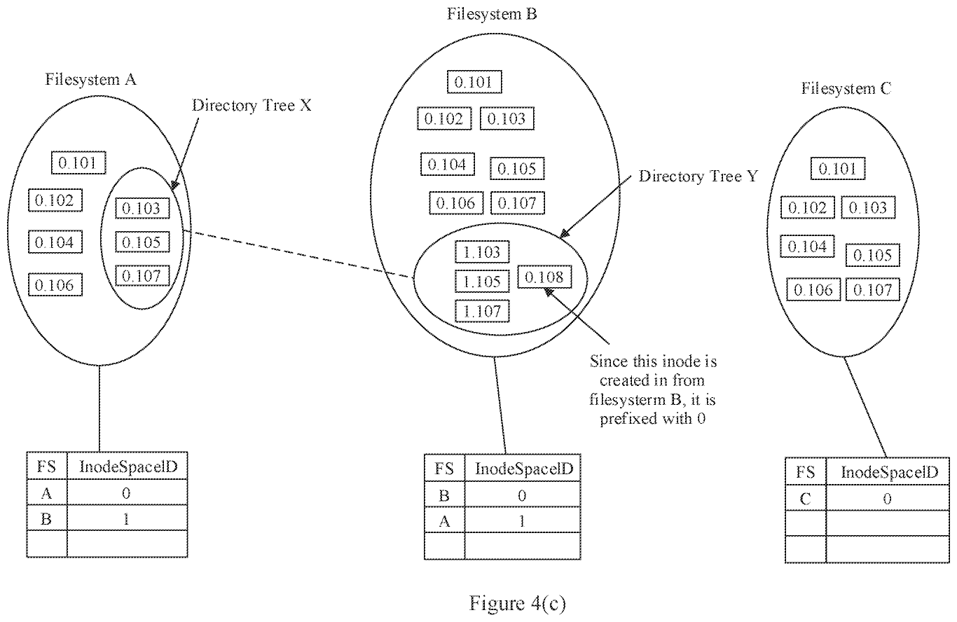

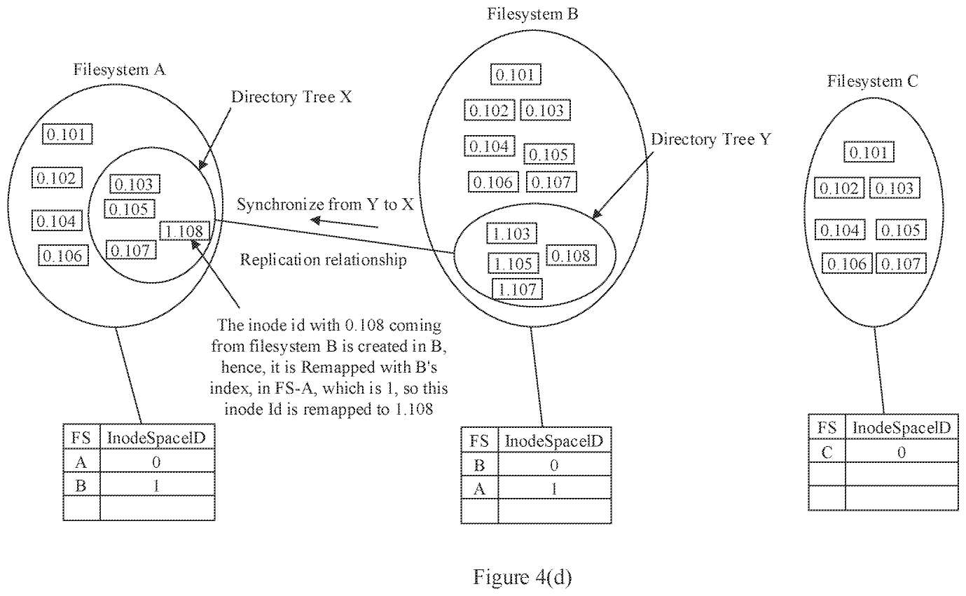

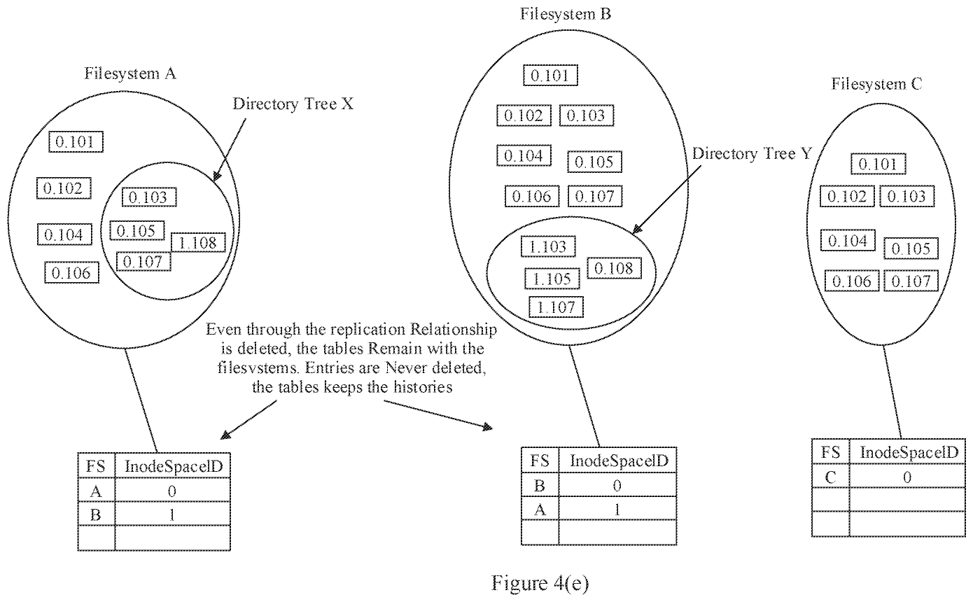

FIGS. 4(a) to 4(e) illustrate the replication relationship between the two filesystems FS A and FS B, according to an implementation of the present disclosure in one scenario. The behaviour of different operations is explained in detail here in below:
a) Creation of a new replication relationship between two tree X in filesystem FSA and tree Y in filesystem FS B: When a replication relationship is established, inodeSpaceID, 1 is allocated in Filesystem B's inodeSpaceTable for FS A & inodeSpaceID, 1 is allocated in FS A's inodeSpaceTable for FS B as illustrated in FIG. 4(a).
b) Replication of inodes from FS A to FS B: The inodes existing in FS A has InodeSpaceID as 0, when they are replicated to FS B, the InodeSpaceID is mapped to 1 as per the InodeSpaceTable as illustrated in FIG. 4(b).
c) Creation of inodes in the destination filesystem FS B after splitting the relationship: As illustrated in FIG. 4(c), the inode creation is local to FS B, so the InodeSpaceID 0 is used.
d) Swapping of replication relationship and transfer of data from FS B to FS A: Inodes created locally in FS B i.e. inodes with InodeSpaceID 0 are mapped to use InodeSpaceID 1 in FS A as shown in FIG. 4(d). Inodes that were transferred from FS A to B in forward direction i.e., inodes with InodeSpaceID 1 are mapped to use InodeSpaceID 0 as per the algorithm defined by this solution.
e) Deleting the replication relationship between Directory tree X and Y: The InodeSpaceTables exchanged are never deleted even though a replication pair is deleted as shown in FIG. 4(e).

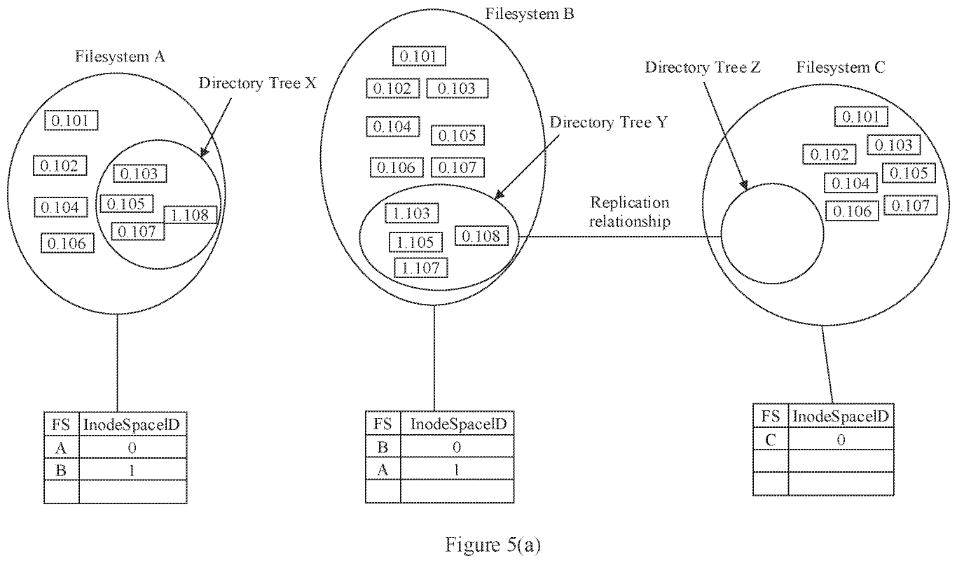

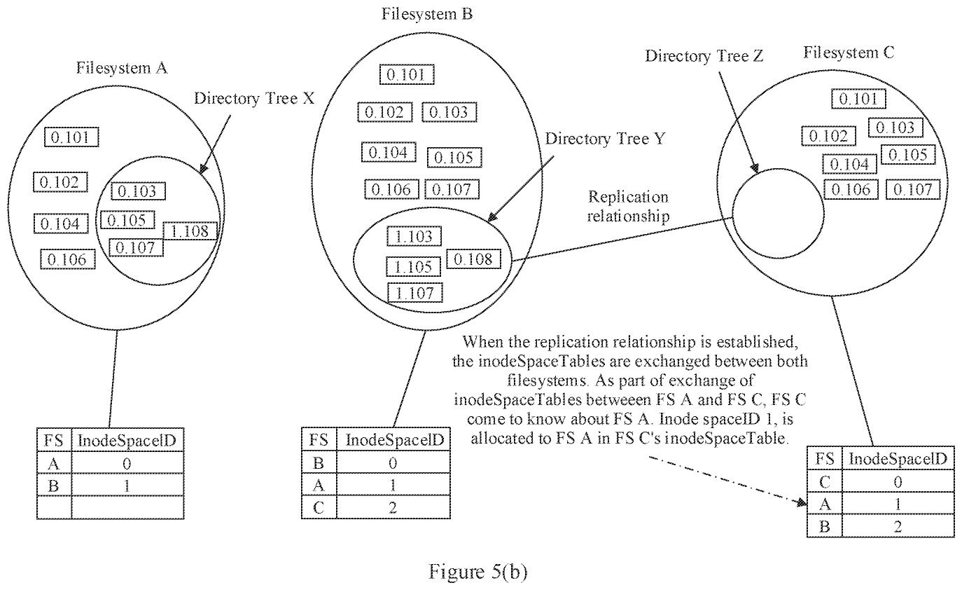

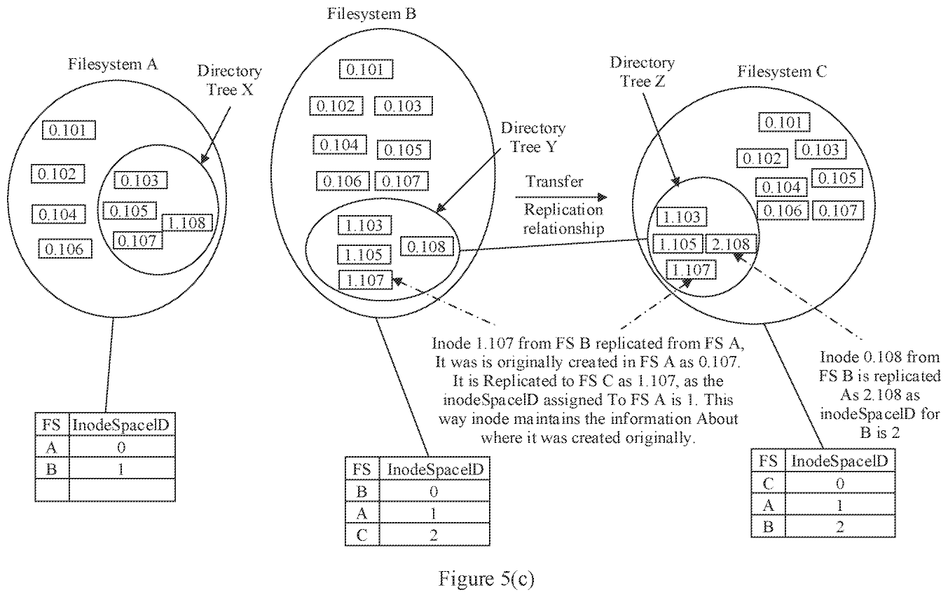

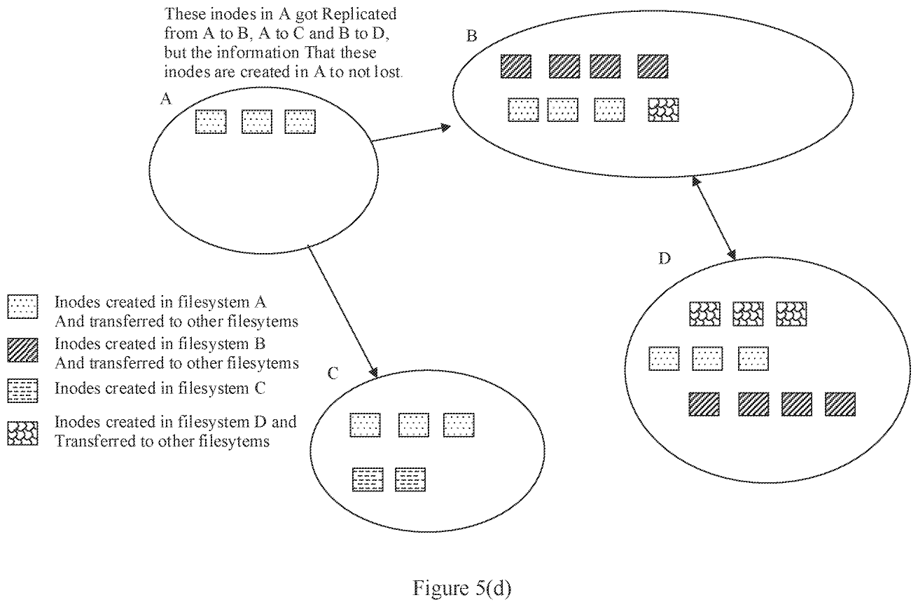

FIGS. 5(a) to 5(d) illustrate the replication relationship between two filesystems FS A and FS B, according to another implementation of present disclosure, in continuation of the first scenario where the InodeSpaceTables of FS A, B are already exchanged and available between each filesystem. The behaviour of different operations is explained in detail hereinbelow:
a) Create a replication relationship between Tree Y in Filesystem B and Tree Z in filesystem C: When a new replication relationship between tree in Filesystem B and a new filesystem is performed, inodeSpace tables are exchanged.
b) Table exchange & inodeSpaceID allocation between the filesystem B and C: The exchange and inodeSpaceID allocation involves the steps of FS C getting both FS A and B's InodeSpaceTable, FS B getting FS C's InodeSpaceTable alone (it already has FS A's InodeSpaceTable), FS C allocate new InodeSpaceID for FSB (2 in FIG. 5(b)) and FS A (1 in FIG. 5(b)) and FS B allocates a new InodeSpaceID for FS C (2 in FIG. 5(b)). As mentioned in the InodeSpaceTable property, the InodeSpaceIndex allocated to FS A by FS B and FS C are different.
c) Replicate inodes from FS B to FS C: Inodes that were locally created at B are mapped with InodeSpaceID 2 and inodes that were replicated from FS A to FS B will be mapped with InodeSpaceID 1 as per the algorithm as illustrated in FIG. 5(c).
d) Replication of inodes across multiple filesystems: FIG. 5(d) depicts that the information about where the inode was actually created remains throughout the life of inode due to the nature of InodeSpaceID and its mapping during replication.

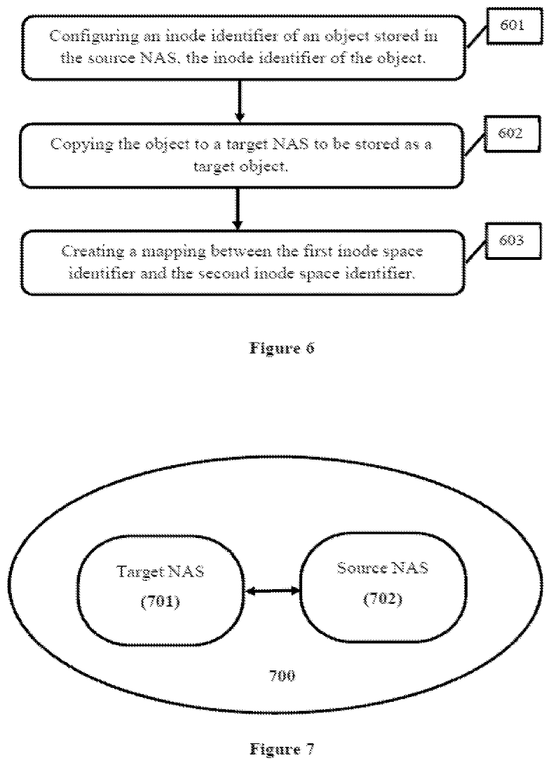

FIG. 6 illustrates the method for asynchronous replication between network-attached storage (NAS) arrays. The method comprising steps as follows.

Step 601: configuring, by a source NAS, an inode identifier of an object stored in the source NAS, the inode identifier of the object having a first inode space identifier and a first local inode identifier, wherein the first inode space identifier indicates that the object is created by the source NAS;

Step 602: copying, by the source NAS, the object to a target NAS to be stored as a target object, wherein an inode identifier of the target object having a second inode space identifier and a second local inode identifier, wherein the second inode space identifier indicates that the target object is received from the source NAS, and wherein the second local inode identifier is identical to the first local inode identifier; and

Step 603: creating, by the source NAS, a mapping between the first inode space identifier and the second inode space identifier.

FIG. 7 illustrates the system (700) for asynchronous replication between network-attached storage (NAS) arrays. The system comprises: at least one target NAS (701); and at least one source NAS (702). The source NAS is adapted to configure an inode identifier of an object stored in the source NAS (702), the inode identifier of the object having a first inode space identifier and a first local inode identifier, wherein the first inode space identifier indicates that the object is created by the source NAS (702). It is also adapted to copy the object to the target NAS (701) to be stored as a target object, wherein an inode identifier of the target object having a second inode space identifier and a second local inode identifier, wherein the second inode space identifier indicates that the target object is received from the source NAS (702), and wherein the second local inode identifier is identical to the first local inode identifier. It is further adapted to create a mapping between the first inode space identifier and the second inode space identifier.

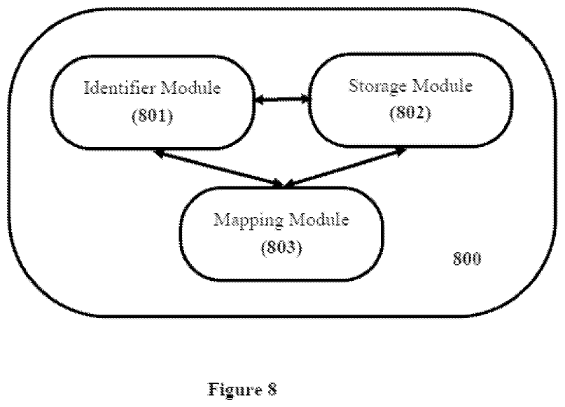

FIG. 8 illustrates the device (800) for asynchronous replication between network-attached storage (NAS) arrays. The device comprises an identifier module (8oi), a storage module (802) and a mapping module (803). The identifier module (8oi) is adapted to configure an inode identifier of an object stored in a source NAS, the inode identifier of the object having a first inode space identifier and a first local inode identifier, wherein the first inode space identifier indicates that the object is created by the source NAS. The storage module (802) is adapted to copy the object to a target NAS to be stored as a target object, wherein an inode identifier of the target object having a second inode space identifier and a second local inode identifier, wherein the second inode space identifier indicates that the target object is received from the source NAS, and wherein the second local inode identifier is identical to the first local inode identifier. The mapping module (803) is adapted to create a mapping between the first inode space identifier and the second inode space identifier.

Significantly, creating the mapping between the first inode space identifier and the second inode space identifier involves: mapping the first inode space identifier to a file system; and mapping the file system to the second inode space identifier. The object includes a file or a directory and all of objects created by the source NAS shares the first inode space identifier. The first inode space identifier is zero, and the second inode space identifier is a non-zero value. The source NAS and the target NAS each comprises at least one file system.

Some of the non-limiting advantages of the present disclosure are mentioned hereinbelow:
It reduces the latency required to perform the source to destination mapping.
It does away with the need for coordination between different replication components running in different nodes sending parts of the filesystem distributes across nodes.
The solution requires very less space when compared to the traditional mapping table solution.

A person skilled in the art may understand that any known or new algorithms be used for the implementation of the present disclosure. However, it is to be noted that, the present disclosure provides a method, a device and a system for asynchronous directory replication to achieve the above mentioned benefits and technical advancement irrespective of using any known or new algorithms.

A person of ordinary skill in the art may be aware that in combination with the examples described in the embodiments disclosed in this specification, units and algorithm steps may be implemented by electronic hardware, or a combination of computer software and electronic hardware. Whether the functions are performed by hardware or software depends on the particular applications and design constraint conditions of the technical solution. A person skilled in the art may use different methods to implement the described functions for each particular application, but it should not be considered that the implementation goes beyond the scope of the present disclosure.

It may be clearly understood by a person skilled in the art that for the purpose of convenient and brief description, for a detailed working process of the foregoing system, apparatus, and unit, reference may be made to a corresponding process in the foregoing method embodiments, and details are not described herein again.

In the several embodiments provided in the present disclosure, it should be understood that the disclosed apparatus, method or system may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

When the functions are implemented in a form of a software functional unit and sold or used as an independent product, the functions may be stored in a computer-readable storage medium. Based on such an understanding, the technical solutions of the present disclosure essentially, or the part contributing to the prior art, or a part of the technical solutions may be implemented in a form of a software product. The computer software product is stored in a storage medium, and includes several instructions for instructing a computer node (which may be a personal computer, a server, or a network node) to perform all or a part of the steps of the methods described in the embodiment of the present disclosure. The foregoing storage medium includes: any medium that can store program code, such as a USB flash drive, a removable hard disk, a read-only memory (ROM), a random access memory (RAM), a magnetic disk, or an optical disc.

Devices that are in communication with each other need not be in continuous communication with each other, unless expressly specified otherwise. In addition, devices that are in communication with each other may communicate directly or indirectly through one or more intermediaries.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Although implementations for a method, a device and a system for asynchronous directory replication by creating unique inode space identifiers and maintaining inode space tables for mapping to reduce the overhead of a lookup, update operations on the distributed mapping table and to reduce space requirement for maintaining the mapping table have been described in language specific to structural features and/or methods, it is to be understood that the appended claims are not necessarily limited to the specific features or methods described. Rather, the specific features and methods are disclosed as examples for implementations of asynchronous directory replication.

What is claimed is:

1. A method, comprising:
configuring, by a source network-attached storage (NAS), an inode identifier of an object stored in the source NAS, wherein the inode identifier of the object has a first inode space identifier and a first local inode identifier, and the first inode space identifier indicates that the object is created by the source NAS;
copying, by the source NAS, the object to a target NAS to be stored as a target object, wherein an inode identifier of the target object has a second inode space identifier and a second local inode identifier, the second inode space identifier indicates that the target object is received from the source NAS, and the second local inode identifier is identical to the first local inode identifier, and
creating, by the source NAS, a mapping between the first inode space identifier and the second inode space identifier.

2. The method according to claim 1, wherein the object comprises a file or a directory.

3. The method according to claim 1, wherein all objects created by the source NAS share the first inode space identifier.

4. The method according to claim 1, wherein the first inode space identifier is zero, and the second inode space identifier is a non-zero value.

5. The method according to claim 1, wherein the source NAS and the target NAS each comprise at least one respective file system.

6. The method according to claim 1, wherein creating the mapping between the first inode space identifier and the second inode space identifier comprises:
mapping the first inode space identifier to a file system; and
mapping the file system to the second inode space identifier.

7. A system, comprising:
at least one target network-attached storage (NAS); and
at least one source NAS, wherein the at least one source NAS is configured to:
configure an inode identifier of an object stored in the at least one source NAS, wherein the inode identifier of the object has a first inode space identifier and a first local inode identifier, and the first inode space identifier indicates that the object is created by the at least one source NAS;
copy the object to the at least one target NAS to be stored as a target object, wherein an inode identifier of the target object has a second inode space identifier and a second local inode identifier, the second inode space identifier indicates that the target object is received from the at least one source NAS, and the second local inode identifier is identical to the first local inode identifier; and
create a mapping between the first inode space identifier and the second inode space identifier.

8. The system according to claim 7, wherein the object comprises a file or a directory.

9. The system according to claim 7, wherein all objects created by the at least one source NAS share the first inode space identifier.

10. The system according to claim 7, wherein the first inode space identifier is zero, and the second inode space identifier is a non-zero value.

11. The system according to claim 7, wherein the at least one source NAS and the at least one target NAS each comprise at least one respective file system.

12. The system according to claim 7, wherein creating the mapping between the first inode space identifier and the second inode space identifier comprises:
mapping the first inode space identifier to a file system; and
mapping the file system to the second inode space identifier.

13. A device, comprising:
an interface; and
a processor coupled to the interface, the processor being configured to:
configure an inode identifier of an object stored in a source network-attached storage (NAS), wherein the inode identifier of the object has a first inode space identifier and a first local inode identifier, and the first inode space identifier indicates that the object is created by the source NAS;
copy the object to a target NAS to be stored as a target object, wherein an inode identifier of the target object has a second inode space identifier and a second local inode identifier, the second inode space identifier indicates that the target object is received from the source NAS, and the second local inode identifier is identical to the first local inode identifier; and
create a mapping between the first inode space identifier and the second inode space identifier.

14. The device according to claim 13, wherein the processor is further configured to:
map the first inode space identifier to a file system; and
map the file system to the second inode space identifier.

15. The device according to claim 13, wherein the object comprises a file.

16. The device according to claim 13, wherein the object comprises a directory.

17. The device according to claim 13, wherein all objects created by the source NAS share the first inode space identifier.

18. The device according to claim 13, wherein the first inode space identifier is zero, and the second inode space identifier is a non-zero value.

19. The device according to claim 13, wherein the source NAS and the target NAS each comprise at least one respective file system.
